(19) United States
(12) Patent Application Publication
(10) Pub. No.: US 2007/0196648 A1
(43) Pub. Date: Aug. 23, 2007

(54) Carbon fiber, process for production thereof, prepregs, and golf club shafts

(76) Inventors: Makoto Endo, Iyo-gun (JP); Hiroyuki Takiyama, Puyallup, WA (US); Nobuya Andou, Komae-shi (JP)

Correspondence Address: RATNERPRESTIA, P O BOX 980, VALLEY FORGE, PA, 19482-0980, US

(21) Appl. No.: 10/592,158

(22) PCT Filed: Mar. 2, 2005
(86) PCT No.: PCT/JP05/03461

§ 371 Date: Sep. 8, 2006

(30) Foreign Application Priority Data
Mar. 11, 2004 (JP) 2004-068618

(51) Int. Cl. D04H 13/00; B32B 27/04; D02G 3/00; B32B 9/00

(52) U.S. Cl. 428/367; 428/364; 428/292.1; 428/299.1

(57) ABSTRACT

A carbon fiber tow composed of many carbon filaments and having a strand tensile strength of 3.8 to 5.5 GPa, a strand tensile modulus of 180 to 220 GPa and a carbon crystal size (Lc) of 13 to 18 Å. This carbon fiber tow can be produced by subjecting a precursor fiber tow composed of many polyacrylonitrile filaments which have a lightness difference (ΔL) of 50 or below and fineness of 1.1 to 1.7 dtex to oxidative stabilization and subjecting the stabilized fiber tow to carbonization with the maximum temperature within the range of 1,100 to 1,300° C. in an inert atmosphere while raising the temperature from 1,000° C. to the maximum temperature at a temperature rise rate of 100 to 2,000° C./min.

### TECHNICAL FIELD

The invention relates to a carbon fiber and its production method. The invention relates to a prepreg comprising the carbon fibers and a matrix resin. The invention relates to a golf shaft in which the carbon fibers are used as one of constituents. The golf shaft of the invention is resistant against torsion and flexure, and has a good hit feeling.

### BACKGROUND ART

A golf shaft made of carbon fiber reinforced composite material is, usually, light and has a high stiffness. For that reason, a golf club comprising such a shaft is used by many golf players, because it has an advantage of increasing head speed at impact, to thereby increase driving distance.

A golf shaft made of steel has, usually, a low modulus. For that reason, a golf club comprising such a shaft has a high hit accuracy and a good hit feeling. However, it was necessary to increase weight of the shaft to achieve a preferable flexural strength and torsional strength. A golf club comprising such a shaft has a problem that, for players of low physical power, the head speed decreases to decrease the driving distance.

In particular, for iron clubs, requirement for hit accuracy and a good hit feeling is increasing rather than ability of driving a ball to a long distance. That is, a golf club having a low flexural modulus and light weight has been required.

In patent reference 1, as a golf shaft made of a carbon fiber reinforced composite material having a low flexural modulus, for example, a hollow shaft in which low modulus carbon fibers having a modulus of 5 to 150 GPa, as a straight layer in which fibers are disposed substantially parallel, are arranged, is proposed. When a carbon fiber having a modulus less than 150 GPa is used, tensile strength or compressive strength is greatly decreases. For that reason, in the shaft disclosed in the patent reference 1 in which such carbon fibers are used, there is a problem that a sufficient flexural strength or torsional strength cannot be obtained. In the patent reference 1, it is proposed that, as well as the straight layer comprising the low modulus carbon fibers of a modulus of 5 to 150 GPa, as a bias layer in which fibers are disposed in bias, to use a carbon fiber of a modulus of 200 GPa or more. However, in such a constitution, there is a problem that it is impossible to sufficiently decrease the flexural strength of the shaft.

In patent reference 2, a tubular body in which a low modulus carbon fibers having a tensile modulus of 5 to 160 GPa and a compressive breaking strain of 1 to 5% are disposed in an angle to the longitudinal direction of the tubular body of +35 to +55° and −35 to −55°, is proposed. That is, it is proposed that a low modulus carbon fiber is used as the bias layer of the tubular body, and it is proposed to use the tubular body as a golf shaft. However, the patent reference 2 proposes that the tubular body contains a straight layer and a bias layer comprising carbon fibers of a modulus of 200 GPa or more. Accordingly, the golf shaft using the tubular body disclosed by the patent reference 2 has a problem that it cannot be a golf shaft of a low flexural strength.

In patent reference 3, acrylonitrile-based carbon fibers having a strand tensile modulus of 13 tf/mm² or more and less than 18 tf/mm² are proposed. It is explained therein that the carbon fiber may be produced by stabilizing acrylic fibers followed by carbonizing at a temperature of 750 to 1000° C. However, a prepreg comprising carbon fibers obtained by such a low temperature carbonizing is not sufficient in mechanical properties such as compressive strength in a composite. In addition, the prepreg is extremely high in moisture absorption. For that reason, composite materials made from the prepreg exhibits voids or wrinkles on a surface thereof due to the water, and quality in appearance deteriorates. Further, there is also a problem that curing of matrix resin such as an epoxy resin is disadvantageously affected.

Patent reference 1: JP 09-277389 A

Patent reference 2: JP 2000-263653 A

Patent reference 3: JP 62-265329 A

### DISCLOSURE OF THE INVENTION

### Problem to be Solved by the Invention

The purpose of the invention is to provide a carbon fiber having excellent flexural strength and torsional strength and being suitable for production of a golf shaft having a low flexural strength. Another purpose of the invention is to provide a production method of such carbon fibers.

### MEANS FOR SOLVING THE PROBLEM

A carbon fiber bundle of the invention comprising many carbon filaments and has a strand tensile strength of 3.8 to 5.5 GPa, a strand tensile modulus of 180 to 220 GPa and a carbon crystal size Lc of 13 to 18 angstroms.

It is preferable that the carbon fiber bundle of the invention has a strand tensile elongation of 2 to 3%.

It is preferable that the carbon fiber bundle of the invention has a water content of 0.5% or less.

It is preferable that the carbon fiber bundle of the invention has a specific gravity of 1.7 to 1.9.

It is preferable that the carbon fiber bundle of the invention comprises 1,000 to 300,000 carbon filaments.

A process for producing a carbon fiber bundle of the invention comprises a stabilization step for stabilizing a precursor fiber bundle comprising a bundle of many polyacrylonitrile-based filaments each of which has a lightness difference ΔL of 50 or less and a fineness of 1.1 to 1.7 dtex, and a carbonization step for carbonizing a stabilized fiber bundle which is produced by the stabilization step, in an inert atmosphere, at a highest temperature of 1,100 to 1,300° C. and at a temperature rising rate of 100 to 2,000° C./min from a temperature of 1,000° C. to the highest temperature.

In the process for producing a carbon fiber bundle of the invention, it is preferable that the lightness difference ΔL is 40 or less.

In the process for producing a carbon fiber bundle of the invention, it is preferable that the highest temperature is in the range of 1,150 to 1,250° C.

A prepreg of the invention comprises a carbon fiber bundle of the invention and a matrix resin.

In the prepreg of the invention, it is preferable that a weight of the carbon fiber bundle is 10 to 250 g/m².

A golf shaft of the invention is formed with a carbon fiber reinforced composite material comprising a carbon fiber bundle of the invention and a resin.

In the golf shaft of the invention, it is preferable that the carbon fiber reinforced composite material is a carbon fiber reinforced composite material obtained by curing a matrix resin of the prepreg of the invention.

### EFFECT OF THE INVENTION

By the carbon fiber bundle of the invention, a carbon fiber reinforced composite material which has a higher compressive strength than that of a carbon fiber reinforced composite material comprising conventional carbon fiber bundles, is provided. By the carbon fiber bundle of the invention, a carbon fiber reinforced composite material which has a lower tensile modulus than that of a carbon fiber reinforced composite material comprising conventional carbon fiber bundles, is provided. A golf shaft made from a prepreg comprising the carbon fiber bundle of the invention and a matrix resin has, a high flexural strength and torsional strength, and moreover, a low flexural modulus. That is, because the golf shaft has a high flex, compared to a golf shaft made of a conventional carbon fiber reinforced composite material, it has a more improved hit feeling and hitting accuracy, while keeping about the same weight.

### BEST EMBODIMENT FOR CARRYING OUT THE INVENTION

The inventors found a carbon fiber bundle having special ranges of a tensile strength, a tensile modulus and a carbon crystal size, and further found that a golf shaft, used for such as an iron club, made from a prepreg comprising the carbon fiber bundles impregnated with a matrix resin, has a high flex, namely a low flexural strength, while maintaining a high flexural strength.

The strand tensile strength of the carbon fiber bundle of the invention is 3.8 to 5.5 GPa. A carbon fiber bundle of which strand tensile strength is 3.8 GPa or more, due to its high tensile elongation at break, does not generate many fluffs. This fact brings about an improvement of quality of prepreg and composite material formed by using the carbon fiber bundle. In addition, this fact also brings about an improvement of tensile strength of the composite material. The strand tensile strength of the carbon fiber bundle of the invention is, preferably 4.0 GPa or more, more preferably 4.2 GPa or more, and still more preferably 4.5 GPa or more.

If a carbon fiber strand tensile strength of carbon fiber bundle is less than 3.8 GPa, a tubular body for golf shaft formed by using a fiber reinforced composite material comprising such a carbon fiber bundle, has not a sufficient tensile strength. It is preferable that the strand tensile strength of carbon fiber bundle is as high as possible, but in view of the purpose of the invention, it is sufficient that the upper limit is 5.5 GPa.

The strand tensile modulus of the carbon fiber bundle of the invention is 180 to 220 GPa. The strand tensile modulus is preferably 190 to 210 GPa. If a carbon fiber strand tensile modulus of carbon fiber bundle is less than 180 GPa, properties such as tensile strength and compressive strength of a tubular body for golf shaft formed by using a fiber reinforced composite material comprising such a carbon fiber bundle, become significantly low. If the strand tensile modulus of carbon fiber bundle exceeds 220 GPa, stiffness of a tubular body, for golf shaft, formed by using a fiber reinforced composite material comprising such a carbon fiber bundle, becomes high, and brings about an insufficient flex.

The measuring methods of strand tensile strength and strand tensile modulus of the carbon fiber bundle of the invention are as follows.

A test piece for the measurement is prepared by impregnating the carbon fiber bundle with a resin which consists of 3,4-epoxycyclohexylmethyl-3,4-epoxycyclohexylcarboxylate 100 wt parts, boron trifluoride monoethylamine 3 wt parts and acetone 4 wt parts, and the resin is cured at 130° C. for 35 minutes.

By using this test piece, the value of strand tensile strength is determined by carrying out a tensile test according to JIS R7601 (1986). The strand tensile modulus is determined from the inclination of stress-strain curve obtained in the tensile test. At this time, the value of strand tensile elongation is also determined from the elongation at break of the test piece.

The carbon crystal size Lc of carbon filament of the carbon fiber bundle of the invention is 13 to 18 angstroms. This fact is important. The carbon crystal size of carbon filament and the compressive properties of the carbon fiber bundle are in an opposite correlation. If carbon crystal size is larger than 18 angstroms, compressive strength of the carbon fiber bundle becomes insufficient. If carbon crystal size is smaller than 13 angstroms, mechanical properties of the carbon fiber bundle become insufficient due to insufficient growth of carbon crystal. Carbon crystal size Lc of carbon filament of the carbon fiber bundle of the invention is, preferably 14 to 17 angstroms.

Measuring method of the carbon crystal size Lc of carbon filament of the carbon fiber bundle of the invention is as described below.

The measurement is carried out by a wide angle X-ray diffractometry. An X-ray diffraction by CuKα-ray as an X-ray source is carried out to a carbon filament. Based on the spectrum obtained by scanning in equatorial direction, the carbon crystal size Lc is determined by the following formula 1 from the half-band width, Be, which corresponds to the peak in the vicinity of 2θ=25 to 26° of the (002) plane.
Carbon fiber crystal size Lc (nm)=λ/(B0×COS θ) (Formula 1)
λ=wavelength of X-ray=0.15148 nm
B0=(Be²−B1²)^{1/2}
(B1 is an apparatus constant. Here, it is 1.046×10⁻² rad)
θ=Bragg angle.

The strand tensile elongation of the carbon fiber bundle of the invention is, preferably 2 to 3%. If the strand tensile elongation is less than 2%, a carbon fiber reinforced composite material made thereof become insufficient in tensile strength. The upper limit of the strand tensile elongation is not especially limited, but for the purpose of the invention, 3% is sufficient.

The measuring method of the strand tensile elongation of the carbon fiber bundle of the invention is the same as explained above.

The water content of the carbon fiber bundle of the invention is, preferably, 0 to 0.5%. If the water content exceeds 0.5%, the water contained in the carbon fiber bundle is also taken into a prepreg prepared by the carbon fiber bundle and a matrix resin. For that reason, when a carbon fiber reinforced composite material is molded by using the prepreg, water evaporates. Due to the evaporated water, voids are formed in the molded composite material, or wrinkles may be formed. Accordingly, it is preferable that the water content of the carbon fiber bundle is 0.5% or less.

The measuring method of the water content of the carbon fiber bundle of the invention is as follows.

A carbon fiber bundle to be subjected to measurement is weighed. Next, the carbon fiber bundle is dried by, such as, in a hot air drier at 120° C. for 2 hours. The carbon fiber bundle is weighed after the drying. Using these data, the water content is calculated according to the following formula 2. Here, the amount of the carbon fiber bundle to be used for the measurement may be about 2 grams.
Water content (%)=(weight before drying−weight after drying)/weight after drying×100 (Formula 2)

It is preferable that a specific gravity of the carbon fiber bundle of the invention is 1.7 to 1.9. If it is less than 1.7, many voids or the like are present in carbon filament which constitutes the carbon fiber bundle, and a denseness of the carbon filament decreases. A carbon fiber reinforced composite material comprising a carbon fiber bundle formed by many of such carbon fiber filaments, has a low compressive strength. If the specific gravity is more than 1.9, improvement in decreasing weight of carbon fiber reinforced composite becomes small. The specific gravity is, more preferably, 1.75 to 1.85.

The measuring method of specific gravity of the carbon fiber bundle of the invention is as follows.

The measurement of the specific gravity is carried out according to the method described in JIS R7601 (1986). A carbon fiber bundle of weight. A is immersed in an unpurified o-dichlorobenzene (for example, special grade of Wako Pure Chemical Industries, Ltd.) of specific gravity ρ prepared as a specific gravity liquid, and weighs the carbon fiber bundle in the specific gravity liquid, and the specific gravity of the carbon fiber bundle are calculated by the following formula 3. Here, the weight. A of the carbon fiber bundle may be 1.0 to 1.5 grams.
Specific gravity of Carbon fiber bundle=(A×ρ)/(A−B) (Formula 3)

The number of carbon filaments in the carbon fiber bundle of the invention is preferably 1,000 to 300,000, more preferably 3,000 to 100,000, still more preferably 6,000 to 50,000, and especially preferably 12,000 to 24,000.

An example of the method for producing the carbon fiber bundle of the invention is as follows.

As a precursor fiber bundle to be supplied to a stabilization step, a bundle of many polyacrylonitrile-based filaments each of which has a lightness difference ΔL of 50 or less and a fineness of 1.1 to 1.7 dtex, is used. The precursor fiber bundle is stabilized in air in the stabilization step. The obtained stabilized fiber bundle is supplied to a carbonization step. In the carbonization step, the stabilized fiber bundle is carbonized in an inert atmosphere at a highest temperature of 1,100 to 1,300° C. and at a temperature rising rate of 100 to 2,000° C./min, from a temperature of 1,000° C. to the highest temperature.

If the fiber fineness of the polyacrylonitrile-based filament which forms the precursor fiber bundle in the production method of the carbon fiber bundle of the invention, is less than 1.1 dtex, since a high modulus may be attained even in a low carbonization temperature, it becomes necessary to lower the carbonization temperature to 1,100° C. or lower in order to obtain a strand tensile modulus of 220 GPa or lower. In this case, there is a problem that water content of the produced carbon fiber bundle becomes high. On the contrary, if the fiber fineness of the polyacrylonitrile-based filament is more than 1.7 dtex, stabilizing treatment inside the filament becomes insufficient. In this case, in the carbonization step, there are problems that fiber breakages generate in portion where stabilization is not sufficient, or the properties of the produced carbon fiber bundle decreases greatly. The fiber fineness of the polyacrylonitrile-based filament is preferably 1.2 to 1.5 dtex.

The denseness of the polyacrylonitrile-based filament which forms the precursor fiber bundle is expressed by lightness difference ΔL. In the production method of the carbon fiber bundle of the invention, the lightness difference ΔL of the polyacrylonitrile-based filament is 50 or less. There is especially no lower limit of the lightness difference ΔL, but in any event if it is 5 or more, the purpose of the invention can be sufficiently achieved. Highly densified filament is unlikely to generate defect on surface of the produced carbon filament, even if it is carbonized with a rapid heating profile. As a result, the produced carbon fiber bundle has a high tensile strength and compressive strength. The lightness difference ΔL is preferably 40 or less, more preferably 30 or less.

The measuring method of lightness difference ΔL of the precursor fiber bundle is as follows.

The lightness difference ΔL is measured by the iodine absorption method. A fiber bundle having 5 to 7 cm fiber length is cut out from the precursor fiber bundle, and dried. Fibers in weight of 0.5 g are taken out from the dried fiber bundle, as a sample to be tested. On the other hand, iodine (I₂) 50.76 g, 2,4-dichlorophenol 10 g, acetic acid 90 g and potassium iodide 100 g are weighed and are put into a 1 liter mess flask and dissolved in water to make an iodine solution for measurement.

The prepared sample to be tested is put into a 200 ml Erlenmeyer flask, and the prepared iodine solution 100 ml is added thereto, and shaken at 60±0.5° C. for 50 minutes. During that, iodine absorption to the sample to be tested is carried out. The sample to which iodine is absorbed is taken out from the flask, and washed for 30 minutes by flowing water. The washed sample is centrifugally dehydrated at 2,000 rpm for one minute. The dehydrated sample is quickly dried in air. The dried sample is separated into individual fibers.

The lightness (L value) of the separated fibers is measured by a Hunter type color difference meter. This measured value is expressed as L1. On the other hand, as for the above-mentioned sample which is not subjected to iodine absorption treatment, its lightness (L value) is measured by the Hunter type color difference meter. This measured value is expressed as L0. The difference of these two measured values, L1−L0, is defined as the lightness difference ΔL. As the Hunter type color difference meter used for the measurement, for example, Color Machine CM-25 sold by Color Machine Co., Ltd., is used.

The acrylic polymer used for production of fiber bundle (precursor fiber bundle) comprising many polyacrylonitrile-based filaments in the production method of the carbon fiber bundle of the invention may be of acrylonitrile 100%, but in view of improving efficiency of stabilization and fiber forming ability, copolymers are preferably used.

As copolymer components, acrylic acid, methacrylic acid and itaconic acid, etc., which are known as stabilization accelerating component, are preferably used. More preferably, copolymers comprising ammonium salts of acrylic acid, methacrylic acid and itaconic acid of which a part or all are neutralized by ammonia is used. Furthermore, as a copolymerization component, in view of improving fiber forming ability, methacrylic ester, acrylic ester, metal salt of allyl sulfonic acid and metal salt of methallyl sulfonic acid, etc, are preferably used.

The amount of the copolymer component in the copolymer is, in total, 0 to 10 mol % is preferable, more preferably 0.1 to 6 mol % and still more preferably 0.2 to 2 mol %. If the amount of the copolymer component is too small, fiber forming ability of the copolymer worsens and if the amount of the copolymer is too much, heat resistance lowers to cause inter filaments welding in the following stabilization step, and considering the balance between the two, the amount of the copolymer component should be determined.

As methods for polymerizing the copolymer, although not especially limited, a solution polymerization method, a suspension polymerization method and an emulsion polymerization method, etc., can be applied.

At spinning an acrylic-based polymer or copolymer, an organic or an inorganic conventionally known solvent can be used, but it is preferable to use an organic solvent. Concretely, as the solvent, dimethylformamide, dimethylacetamide, and dimethylsulfoxide or the like are used.

A spinning liquid comprising acrylic-based polymer or copolymer and a solvent is extruded through a spinneret by conventionally known wet spinning method, dry-jet spinning method, dry spinning method or melt-spinning method, taken into a coagulation bath to coagulate, and fiber bundles are formed. As the spinning methods, wet spinning method or dry-jet spinning method is preferable. In the coagulation bath, it is possible to add a conventionally known coagulation accelerator, and the coagulation speed can be controlled by the temperature of the coagulation bath and the concentration of the coagulation accelerator. As the coagulation accelerator, those which do not dissolve the above-mentioned acrylic-based polymer or copolymer but compatible with the solvent used for the spinning liquid, can be used, and concretely, water is preferable.

In the wet spinning or dry-jet spinning, by adjusting the polymer concentration in the spinning liquid, coagulation bath temperature and drawing bath temperature in proper ranges, it is possible to obtain a coagulated fiber of which skin layer formed on fiber surface is thick, and fibril unit constituting the fiber is small, can be obtained. By drawing such a coagulated fiber by a method described below, it is possible to obtain a dense precursor fiber bundle having smooth surface. Concretely, it is preferable that the polymer concentration in the spinning liquid is selected in the range of 18 to 30 wt %, the temperature of the coagulation bath is controlled in the range of 0 to 30° C. and the drawing bath temperature is controlled 50° C. or higher than that of the coagulation bath temperature

Many filaments extruded from the spinneret are taken into the coagulation bath to coagulate and a fiber bundle is formed. The fiber bundle becomes, via washing, drawing, imparting oil agent, and drying, a precursor fiber bundle comprising many polyacrylonitrile-based filaments, which is used for production of the carbon fiber bundle of the invention.

The fiber bundle may further be drawn by steam, after being imparted with an oil agent. The fiber bundle may directly be drawn, after coagulation, in a drawing bath without water washing, or may be drawn in a drawing bath after removing the solvent by water washing. Such drawing in bath is, usually, carried out in a single or a several drawing bathes maintained at 30 to 98° C. The amount of solvent, which is used in the above-mentioned spinning liquid, in these water washing bath and the drawing bath should preferably be determined so that the amount of solvent in the coagulation bath is the upper limit.

After drawing in the bath, it is preferable to impart an oil agent comprising silicone, etc., to the fiber bundle. It is preferable that the silicone oil agent contains a modified silicone, especially, an amino-modified silicone which is excellent in heat resistance.

It is preferable that the fiber bundle which was drawn in a bath and imparted with an oil agent, is dried by heating. It is efficient that the drying treatment is carried out by contacting the fiber bundle with a roll heated at a temperature of 50 to 200° C. It is preferable to dry the fiber bundle such that the water content is 1 wt % or less, to densify fiber structure of the filament.

In the precursor fiber bundle used in the production method of the carbon fiber bundle of the invention, it is preferable that a number of filaments in the fiber bundle is 1,000 to 300,000, more preferably 3,000 to 100,000, still more preferably 6,000 to 50,000 and especially preferably 12,000 to 24,000.

The precursor fiber bundle obtained as above-mentioned, is stabilized in an ordinary way. That is, it is preferable that the precursor fiber bundle is stabilized in the temperature range of 200° C. to 300° C. in air. It is preferable that a draw ratio at the stabilizing treatment is made high, in view of increasing strand tensile strength of carbon fiber bundle to be obtained, in the range such that a fluff does not generate. It is preferable that the draw ratio at the stabilization step is 0.7 to 1.2. If the draw ratio is less than 0.7, the strand tensile strength of the carbon fiber bundle decreases. If the draw ratio exceeds 1.2, although the strand tensile strength increases, fluffs generate and the bundle becomes difficult to be handled. The draw ratio at the stabilization step is, more preferably 0.8 to 1.1. The draw ratio means the ratio of a speed V1 (m/min) of the precursor fiber bundle on a carrying roll just before the stabilization step to a speed V2 of the stabilized fiber bundle on a carrying roll just after the stabilization step, namely, the value of V2/V1.

In the stabilization step, in view of strand tensile strength of carbon fiber bundle to be obtained, processability of carbonization step, and increasing carbonization yield, it is preferable to continuously stabilize until the specific gravity of the stabilized fiber bundle becomes 1.25 to 1.50. The specific gravity of the stabilized fiber bundle is, more preferably 1.28 to 1.45, and still more preferably 1.30 to 1.40.

The stabilization time can be determined properly so that a preferable stabilizing degree can be attained, but in view of improving performance and productivity of the carbon fiber bundle to be obtained, it is preferably 10 to 100 minutes, more preferably 20 to 60 minutes. The stabilization time means the total time in which the fiber bundle stays in the stabilizing furnace. If the stabilization time is less than 10 minutes, the structural difference between surface portion and central portion of the stabilized filaments becomes large, to thereby decrease strand tensile strength and strand tensile modulus of the carbon fiber bundle to be obtained. On the other hand, if the stabilization time exceeds 100 minutes, productivity decreases.

The carbonization step in which the stabilized fiber bundle thus obtained is carbonized, is preferably separated to a pre-carbonization step and the subsequent carbonization step.

In the pre-carbonization step, it is preferable to heat-treat the stabilized fiber bundle at a temperature of 500 to 1,000° C. in an inert atmosphere. If the temperature is 500° C. or less, decomposition or deterioration of the fiber bundle in the next carbonization step is significant, and performance as carbon fiber bundle may deteriorate. At temperature above 1,000° C., it becomes difficult to maintain tension of fiber bundle in the next carbonization step, strand tensile modulus of the carbon fiber bundle to be produced may become lower than 200 GPa. The temperature of the pre-carbonization step is, more preferably 600 to 900° C.

The draw ratio in the pre-carbonization step is, in view of improving strand tensile strength of the carbon fiber bundle to be produced, is preferably high in the range such that fluffs do not generate, and preferably 0.8 to 1.3. If the draw ratio is less than 0.8, strand tensile strength of the carbon fiber bundle to be produced may become less than 3.8 GPa, and if the draw ratio exceeds 1.3, strand tensile strength of the carbon fiber bundle to be produced is improved, but fluffs generate and the fiber bundle may become difficult to be handled. The draw ratio in the pre-carbonization step is, more preferably, 0.9 to 1.2.

In the subsequent carbonization step, the fiber bundle is carbonized at a highest temperature of 1,100 to 1,300° C. in an inert atmosphere. If the highest temperature exceeds 1,300° C., strand tensile modulus of the carbon fiber bundle to be produced becomes too high, and causes a problem that flexural modulus of a tubular body (golf shaft) made from a composite material produced using this carbon fiber bundle decreases. When carbonizing temperature is elevated, due to growing carbon crystal, crystal size Lc of carbon filament of the carbon fiber bundle to be produced exceeds 18 angstroms. As a result, compressive properties of the carbon fiber reinforced composite material produced from such a carbon fiber bundle becomes insufficient, and causes a problem that flexural strength or torsional strength of the tubular body (golf shaft) made from a composite material produced using such a carbon fiber bundle decreases.

When the highest temperature is lower than 1,100° C., crystal size Lc of the carbon filament of the carbon fiber bundle to be produced becomes smaller than 13 angstroms. This means that growth of the carbon crystal is insufficient. In this case, water content of the carbon fiber bundle becomes high. If a carbon fiber reinforced composite material is made using such a carbon fiber bundle, curing of matrix resin becomes insufficient and tensile strength of carbon fiber reinforced composite material may not be developed sufficiently. The highest temperature is more preferably 1,150 to 1,250° C.

In the subsequent carbonization step, the fiber bundle is carbonized with a temperature rising rate of 100 to 2,000° C./min at from a temperature of 1,000° C. to the highest temperature. If the temperature rising rate is less than 100° C./min, the carbonization progresses inside the filament which constitutes the fiber bundle, and causes a problem that strand tensile modulus of the carbon fiber bundle to be produced increases. If the temperature rising rate exceeds 2,000° C./min, carbon structure of the filament is destructed in the carbonization step, and a problem comes up which causes fiber breakage, etc. The temperature rising rate is preferably 150 to 1,000° C./min, more preferably 200 to 500° C./min.

To the produced carbon fiber bundle, in order to modify its surface, it is possible to carry out a publicly known electrolysis treatment. For the electrolysis liquid used for the electrolysis treatment, acidic solutions such as sulfuric acid, nitric acid and hydrochloric acid, alkalis such as sodium hydroxide, potassium hydroxide, tetraethylammonium hydroxide and an aqueous solution of their salts, can be used. Here, an electric variable necessary for the electrolysis treatment is suitably determined depending on the type of carbon fiber bundle to be treated.

By such an electrolysis treatment, normalization of adhesion of the carbon fiber bundle and a matrix resin in the carbon fiber reinforced composite material is conducted, and it become possible to more suitably exhibit strength characteristics in good balance in the carbon fiber reinforced composite material to be produced.

In order to impart a unity to the obtained carbon fiber bundle, the carbon fiber bundle may be treated with a sizing agent. As sizing agents, sizing agents compatible with the matrix resin constituting the carbon fiber reinforced composite material are suitably selected depending on type of the matrix resin used.

The carbon fiber bundle of the invention is processed with a matrix resin into a prepreg. The prepreg of the invention comprises the carbon fiber bundle of the invention and the matrix resin.

As producing methods of the prepreg, there are, for example, a wet method in which a matrix resin is dissolved in solvents such as methylethyl ketone or methanol to lower its viscosity and impregnated into carbon fiber bundle, and a hot melt method in which a matrix resin is heated to lower its viscosity and impregnate it into carbon fiber bundle.

The hot melt method is preferably applied since there is no residual solvent in the prepreg. As hot melt methods, there are, for example, a method in which an epoxy resin composition heated to decrease its viscosity is directly impregnated into carbon fiber bundle, and a method in which a resin coated film, in which a releasing paper or the like is coated with an epoxy resin composition, is made first, and then this resin coated film is overlaid on one or both sides of carbon fiber bundle and heated and pressed to thereby impregnate the epoxy resin composition into carbon fiber bundle.

As matrix resins, for example, an unsaturated polyester resin, a phenol resin and an epoxy resin, etc., are used, but as the matrix resin for the prepreg of the invention used for a golf shaft production, an epoxy resin is generally used.

As the epoxy resin, a compound which has plural epoxy groups in its molecule is used. In particular, amines, phenols and compounds which have carbon-carbon double bond are preferably used. For example, bisphenol type epoxy resins such as a bisphenol A type epoxy resin, a bisphenol F type epoxy resin, a bisphenol S type epoxy resin and tetrabromobisphenol A type epoxy resin, novolac type epoxy resins such as a phenol novolac type epoxy resin and a cresol novolac type epoxy resin, glycidyl amine type epoxy resins such as tetraglycidyl diaminodiphenylmethane, triglycidyl aminophenol and tetraglycidyl xylenediamine, or a combination of the above, are preferably used.

As curing agents used for such the epoxy resin composition, a compound which has an active group capable of reacting with epoxy group, can be used, but especially, a compound which has amino group, an acid anhydride group or an azide group, is preferably used. Concretely, dicyandiamide, various isomers of diaminodiphenyl sulfone and aminobenzoic acid esters are preferably used.

As resins to be used in combination with the carbon fiber bundle of the invention, a resin of which prepreg gives a cured product having a glass transition temperature of 80° C. to 250° C. is preferable. The glass transition temperature of the cured product of the prepreg is more preferably 90° C. to 190° C., especially preferably 100° C. to 150° C. A resin which satisfies this condition, due to its plastic deformation ability, makes the maximum use of a high strand tensile elongation at a low strand tensile modulus which is the characteristic of the carbon fiber bundle of the invention.

If a glass transition temperature of cured product of the prepreg exceeds 250° C., a residual heat stress of the carbon fiber reinforced composite material may become large or a cured product may become brittle, and a combination thereof with the carbon fiber bundle of the invention may decrease strength properties of the obtained carbon fiber reinforced composite material. If a glass transition temperature of cured product of the prepreg is lower than 80° C., a heat resistance of the obtained carbon fiber reinforced composite material becomes insufficient and may greatly decrease strength at a high temperature, or when the surface of the carbon fiber reinforced composite material is polished, some inconveniences of processing may occur such that a heat-softened resin causes clogging of the polisher.

As matrix resins composition for achieving the above-mentioned preferable glass transition temperature, for example, resin compositions comprising bi-functional long chain epoxy resin having epoxy equivalent of 400 to 1,000, etc., are proposed, but they are not limited thereto.

The measuring method of the glass transition temperature of cured product of prepreg is described below.

The prepreg prepared is heat-cured at a temperature of 130° C. for 2 hours in a curing oven. For the obtained carbon fiber reinforced composite material, a measurement of glass transition temperature is carried out according to the description of JIS K7121 (1987), using a differential scanning calorimeter (DSC). Into a 50 μl sealable type sample holder, put 15 to 20 mg sample to be measured, elevates temperature from 30 to 200° C. at temperature rising rate of 40° C./min and obtains a DSC curve. As an apparatus for measurement, for example, Pyris 1 DSC sold by Perkin Elmer can be used. In a portion where a stepwise change is shown in the obtained DSC curve, the temperature where a straight line in horizontally same distance from extended straight lines of each base line and a curve of the stepwise change of the glass transition crosses is defined as the glass transition temperature.

In the prepreg of the invention, it is preferable that a weight content of carbon fiber in the prepreg is 50 wt % or more. In this case, a decreasing weight of the tubular body (golf shaft) made from this prepreg is promoted. In order to decreasing weight of the tubular body (golf shaft) more, it is more preferable that the weight content of carbon fiber is 60 wt % or more. It is preferable that the weight content of carbon fiber in the prepreg is 90 wt % or less. If the weight content of carbon fiber exceeds 90 wt %, voids are generated in the tubular body (golf shaft) made from such a prepreg and a strength of the tubular body may decreases.

In the prepreg of the invention, it is preferable that a weight of carbon fiber per 1 m² prepreg, namely weight of carbon fiber is 10 to 250 g/m². If the weight of the carbon fiber in the prepreg exceeds 250 g/m², the decreasing effect of weight of a tubular body made from such a prepreg may not be sufficient. If a weight of carbon fiber is less than 10 g/m², a production cost of a tubular body may become high, since it is very difficult to process into a tubular body at making a tubular body from such a prepreg. A weight of carbon fiber in prepreg is, more preferably, to 200 g/m².

The prepreg of the invention is used for production of golf shaft. For example, after laminating the prepreg of the invention, by heat-curing the matrix resin in the prepreg while pressurizing the laminate, a golf shaft can be produced. As molding methods in which heat and pressure are applied, there are, for example, a press molding, an autoclave molding, a bagging molding, a wrapping tape molding and an internal pressure molding. In particular, as for sports goods, the wrapping tape molding and the internal pressure molding are preferably used.

The wrapping tape method is a method in which a prepreg is wound around a core metal such as a mandrel to obtain a cylindrical molding. Concretely, it is a method in which the prepreg is wound around the mandrel, a wrapping tape made of a thermoplastic resin film is wound outside the prepreg in order to fix the prepreg and to impart pressure, and after heat-curing the rein in an oven, the core metal is removed to obtain a cylindrical molding (tubular body or golf shaft).

The internal pressure molding is a method in which a preform made by winding a prepreg on an internal pressure imparting body such as a thermoplastic resin tube is set in a mold, next, pressurizing the internal pressure imparting body by supplying a high pressure gas simultaneously with heating the mold, to obtain a cylindrical molding (tubular body or golf shaft).

In the above-mentioned cylindrical molding (tubular body or golf shaft), the prepreg of the invention can be used as a straight layer, a bias layer or both of the cylindrical molding. When the prepreg of the invention is used as the bias layer, it is possible to make the maximum use of the characteristic of low modulus of the carbon fiber bundle of the invention in the prepreg. If a high flexural strength of the cylindrical molding is necessary, by using the prepreg of the invention as the straight layer, it is possible to make the maximum use of a high compressive strength of the carbon fiber bundle of the invention in the prepreg.

Next, the invention is explained further, based on examples and comparative examples. The invention is not limited at all by these examples, etc. The respective measured values in the examples and comparative examples are determined by the following methods.

Carbon Crystal Size Lc:

20 mg of carbon fiber is precisely weighed from a carbon fiber bundle cut into 40 mm length, to prepare a sample to be tested. After arranging the fibers such that the fiber axes of the test sample are precisely parallel, they are impregnated with a diluted collodion alcohol solution and a rectangular columnar test piece having a width of 1 mm and a uniform thickness was prepared. For the obtained rectangular columnar test piece, predetermined values were measured by X-ray diffractometer supplied by Rigaku Corp. Regarding the measuring conditions, CuKα radiation monocolored by Ni filter was used as X-ray source with an output of 40 KV-20 mA, and a scintillation counter was used as counter, to carry out the measurement. From the half-band width, Be, of the diffraction peak in the vicinity of 2θ=25 to 26° corresponding to the (002) plane, the carbon crystal size Lc is determined by the following formula 4.
Carbon crystal size Lc (nm)=λ/(B0×COS θ) (Formula 4)
λ: wavelength of X-ray=0.15148 nm
B0=(Be²−B1²)^{1/2}
(B1 is an apparatus constant. Here, it is 1.046×10⁻² rad)
θ=Bragg angle

0° Tensile Strength and 0° Tensile Modulus of Plate Made of Carbon Fiber Reinforced Composite Material:

After disposing many carbon filaments unidirectionally in a sheet form, resin films were overlaid on both surfaces to impregnate with the resin between the carbon filaments to prepare a unidirectional prepreg. Next, 11 sheets of the prepared prepregs were laminated, heated and pressured at a temperature of 130° C. under a pressure of 0.3 MPa for 2 hours in an autoclave to cure the resin, and a unidirectional composite material was prepared. From the prepared composite material, a platy test piece of 6.4 mm width and 14 mm length was prepared according to ASTM D 3039 (1995). Next, 0° tensile strength and 0° tensile modulus of this test piece, namely of the plate made of the carbon fiber reinforced composite material, were measured.

0° Compressive Strength of Plate Made of Carbon Fiber Reinforced Composite Material:

The above-mentioned unidirectional prepregs were laminated in a same direction and heated and pressured at a temperature of 130° C. under a pressure of 0.3 MPa for 2 hours in an autoclave to cure the resin, and a unidirectional composite material of 1 mm thickness was prepared. From the prepared composite material, a platy test piece of 1±0.1 mm of thickness, 12.7±0.13 mm width, 80±0.013 mm length and 5±0.13 mm gauge portion length was prepared. For this test piece, compressive strength was measured under a shear rate of 1.27 mm/min, using a pressuring device indicated in ASTM D695 (1996). A 0° compressive strength of the test piece, namely of the plate made of the carbon fiber reinforced composite material was obtained by converting the obtained measured value to that of fiber volume ratio of 60%.

In the following, 0° tensile strength, 0° tensile modulus and 0° compressive strength of a plate of carbon fiber reinforced composite material may together be expressed as mechanical properties of platy composite.

Preparation of Cylinder Made of Carbon Fiber Reinforced Composite Material (CFRP):

A CFRP cylinder having a laminate structure of [0₃/±45₃] relative to cylindrical axial direction and inner diameter of 10 mm was prepared according to the procedures (a) to (e) described below. As the mandrel, a stainless round rod was used. The mandrel had 1,000 mm length and 10 mm diameter.

(a) 2 rectangular sheets of 800 mm length and 103 mm width were cut out from the unidirectional prepreg for the bias material. A sample was prepared by superposing the two rectangular prepreg such that the respective fiber directions intersect with each other, and furthermore, shifted with each other 16 mm (corresponding to a half way around the mandrel).

(b) The prepared sample was wound around the mandrel treated with a releasing agent such that the longitudinal axes of the prepreg and the mandrel are in accord, to prepare a bias material layer.

(c) One rectangular prepreg sheet of 800 mm width and 112 mm length was cut out from the unidirectional prepreg for straight material such that the fiber direction is in accord with the mandrel axis, and the rectangular prepreg was wound on the above-mentioned bias material layer such that the fiber direction is in accord with the axis of the mandrel, to form the straight material layer.

(d) A wrapping tape (heat resistant film tape) was wound on the straight material layer, and heat molded in a curing oven at 130° C. for 2 hours, to produce a cured molded product.

(e) A CFRP cylinder was obtained by removing the mandrel from the molded product and removing the wrapping tape.

Measurement of Physical Properties of Cylinder Made of Carbon Fiber Reinforced Composite Material (CFRP):

A. Measurements of Flexural Strength and Flexural Modulus:

A bending fracture load of the prepared CFRP cylinder having an inner diameter of 10 mm were measured according to the three point flexural test described in “Approval Standard and Standard Confirmation Method for Golf-Club shafts” (Edited by Product Safety Association, Minister of International Trade and Industry Approval No. 5 Industrial 2087, 1993). Distance between supports and test speed were set as 300 mm and 5 mm/min, respectively. The flexural strength was determined by the following formula 5 using the measured load value, and the flexural modulus was determined by the following formula 6 based on crosshead deflection (degree of flexure) at a load of 500N.

Flexural Strength F (MPa):
F=8d1×N×L/[π(d1⁴−d2⁴)] (Formula 5)

Flexural Modulus E (GPa):
E=4L³W/[3π(d1⁴−d2⁴)V×1000] (Formula 6)
L: distance between supports (mm)
W: load (N)
d1: inner diameter (mm)
d2: outer diameter (mm)
V: crosshead deflection (degree of flexure) (mm)
N: load at break (N)

B. Measurement of Torsional Strength:

A test piece of 400 mm length was cut out from the produced CFRP cylinder with inner diameter of 10 mm, and a torsion test was carried out according to three point flexural test described in “Approval Standard and Standard Confirmation Method for Golf-Club shafts” (Edited by Product Safety Association, Minister of Industry and Trade Admission No. 5 Industry 2087, 1993). Gauge length of the test piece was made 300 mm, and 50 mm from both ends of the test piece was hold by clamps. The torsional strength was determined by the following formula 7.
Torsional strength (N·m·deg)=torque at break (N·m)×torsion angle at break (degree) (Formula 7)

Hereinafter, flexural strength, flexural modulus and torsional strength of the cylinder made of carbon fiber reinforced composite material may together be expressed as mechanical properties of cylindrical composite.

### EXAMPLE 1

A copolymer comprising 99.5 mol % acrylonitrile and 0.5 mol % acrylic acid was obtained by a solution polymerization in dimethylsulfoxide as solvent, and obtained a spinning liquid of which copolymer component content is 22 wt %. A spinneret having a spinning hole diameter 0.15 mm and number of spinning holes 3,000 was used. By a dry-jet spinning method in which the spinning liquid was extruded from the spinning holes into air at a temperature of 40° C. and after passing through 4 mm length in air, it was introduced into a coagulation bath comprising an aqueous solution of 35 wt % dimethylsulfoxide which was controlled at a temperature of 3° C., obtained a coagulated fiber bundle. The coagulated fiber bundle washed with water, drawn 3.5 times in hot water having a temperature of 90° C., and then, imparted with an oil agent containing an amino-modified silicone, to thereby obtain a drawn fiber bundle having the oil agent. The drawn fiber bundle was subjected to a drying-densification treatment using a hot roller having a temperature of 160° C. Next, the obtained fiber bundle was drawn in a pressurized steam of 0.3 MPa-G. The total draw ratio in the whole fiber production steps was made to 13 times. From these steps, a polyacrylonitrile fiber bundle having a filament fineness of 1.3 dtex and a number of filaments of 3,000 was produced. The lightness difference ΔL of the polyacrylonitrile fiber bundle was 35.

Four of the obtained polyacrylonitrile fiber bundles were integrated and obtained a precursor fiber bundle having a number of filaments 12,000. The precursor fiber bundle was stabilized in air at a temperature of 250° C. for 1 hour in a stabilization furnace of a hot air circulation type. The obtained stabilized fiber bundle was subjected to a pre-carbonization treatment in an inert atmosphere, by rising temperature from 300° C. to 1,000° C. at a temperature rising rate of 500° C./min. Next, the pre-carbonized fiber bundle was carbonized in an inert atmosphere at highest temperature of 1,200° C. At that time, the temperature rising rate from 1,000° C. to 1,200° C. was set to 500° C./min.

The physical properties of the obtained carbon fiber bundle were determined by the above-mentioned method. A carbon fiber filament sheet was prepared by disposing carbon fiber filaments of the obtained carbon fiber bundle unidirectionally.

On the other hand, a resin composition consisting of bisphenol A diglycidylether resin (“Epikote” (trademark) 1001, sold by Japan Epoxy Resin Co. Ltd.) 30 wt %, bisphenol A diglycidylether resin (“Epikote” (trademark) 828, sold by Japan Epoxy Resin Co. Ltd.) 30 wt %, phenol-novolac polyglycidylether resin (Epiclon” (tradename)-N740, sold by DaiNippon Ink and Chemicals, Inc.) 27 wt %, polyvinylformal resin (“Vinylec” (tradename) K, sold by Chisso Corp.) 5 wt %, dicyandiamide (DICY7, sold by Japan Epoxy Resin Co., Ltd.) 4 wt %, and 3-(3,4-dichlorophenol)-1,1-dimethylurea (DCMU-99, sold by Hodogaya Chemical Co., Ltd., curing agent) 4 wt %, was coated on release paper using a reverse roll coater and obtained 2 resin films.

A laminate was prepared by superposing one of the prepared resin film on one side of the prepared carbon filament sheet and another one of the prepared resin film on another side of the prepared carbon filament sheet, respectively. The obtained laminate was heated, pressurized to impregnate the above-mentioned resin composition coated on the resin film into spaces between the carbon filaments. By this procedure, a prepreg having a carbon fiber weight of 125 g/m² was obtained.

Mechanical properties of a platy carbon fiber reinforced composite material were measured by the above-mentioned method using the prepreg. Furthermore, a prepreg for bias layer made of a carbon fiber bundle having tensile modulus of 230 GPa, fiber fineness of 0.8 g/m and number of filaments of 12,000 (T700SC-12K-50C sold by Toray Industries, Inc.), and the prepreg for straight layer made of carbon fiber bundle prepared by this example were used in combination, and according to the above-mentioned method, a cylindrical carbon fiber reinforced composite material (CFRP shaft) was made, and its mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 2

A carbon fiber bundle was prepared in the same way as Example 1, except changing the highest temperature of the carbonization step to 1,150° C. In addition, from the prepared carbon fiber bundle, a prepreg was prepared in the same way as Example 1. Using this prepreg, a platy carbon fiber reinforced composite and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 3

A carbon fiber bundle was prepared in the same way as Example 1, except changing the highest temperature of the carbonization step to 1,100° C. and the temperature rising rate in carbonization step to 200° C./min. In addition, from the prepared carbon fiber bundle, a prepreg was prepared in the same way as Example 1. Using this prepreg, a platy carbon fiber reinforced composite and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 4

A copolymer comprising 99.5 mol % acrylonitrile and 0.5 mol % acrylic acid was obtained by a solution polymerization in dimethylsulfoxide as solvent, and obtained a spinning liquid of which copolymer component content is 28 wt %. A spinneret having a spinning hole diameter 0.15 mm and number of spinning holes 3,000 was used. By a dry-jet spinning method in which the spinning liquid was extruded from the spinning holes into air at a temperature of 45° C. and after passing through 4 mm length in air, it was introduced into a coagulation bath comprising an aqueous solution of 35 wt % dimethylsulfoxide which was controlled at a temperature of 3° C., obtained a coagulated fiber bundle. The coagulated fiber bundle washed with water, drawn 3.5 times in hot water having a temperature of 90° C., and then, imparted with an oil agent containing an amino-modified silicone, to thereby obtain a drawn fiber bundle having oil agent. The drawn fiber bundle was subjected to a drying-densification treatment using a ot roller having a temperature of 160° C. Next, the obtained fiber bundle was drawn in a pressurized steam of 0.3 MPa-G. The total draw ratio in the whole fiber production steps was made to 13 times. From these steps, a polyacrylonitrile fiber bundle having a filament fineness of 1.3 dtex and a number of filaments of 3,000 was produced. The lightness difference ΔL of the polyacrylonitrile fiber bundle was 20.

A carbon fiber bundle and a prepreg comprising the carbon fiber bundle were prepared in the same way as Example 1, using the obtained polyacrylonitrile fiber bundle. Using the prepreg, a platy carbon fiber reinforced composite material and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 5

A precursor fiber bundle of filament fineness of 1.2 dtex was obtained by decreasing extruding amount of the spinning liquid from the spinning holes, in the production process of the precursor fiber bundle of Example 1. From the precursor fiber bundle, a carbon fiber bundle and a prepreg made thereof were prepared in the same way as Example 1, except changing the highest temperature of the carbonization step to 1,300° C. and the temperature rising rate in carbonization step to 300° C./min. Using the prepreg, a platy carbon fiber reinforced composite material and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 6

A precursor fiber bundle of filament fineness of 1.6 dtex was obtained by increasing extruding amount of the spinning liquid from the spinning holes, in the production process of the precursor fiber bundle of Example 1. From the precursor fiber bundle, a carbon fiber bundle and a prepreg made thereof were prepared in the same way as Example 1, except changing the highest temperature of the carbonization step to 1,100° C. Using the prepreg, a platy carbon fiber reinforced composite and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### EXAMPLE 7

A carbon fiber bundle and a prepreg made thereof were prepared according to the same way as Example 3, except changing the temperature rising rate from a temperature of 1,000° C. to the highest temperature in the carbonization step to 3,000° C./min. The carbon fiber bundle generated, compared to those of Examples 1 to 6, many fluffs and prepreg quality was also not good due to the fluffs of the carbon fiber bundle. Using the prepreg, a platy carbon fiber reinforced composite and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3.

### COMPARATIVE EXAMPLE 1

A carbon fiber bundle and a prepreg made thereof were prepared in the same way as Example 1, except changing the highest temperature of the carbonization step to 1,400° C. and the temperature rising rate in carbonization step to 200° C./min. Using the prepreg, a platy carbon fiber reinforced composite and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this comparative example are shown in Tables 1 to 3. The strand tensile modulus was high and the flexural modulus of the cylindrical CFRP shaft also became high.

### COMPARATIVE EXAMPLE 2

A carbon fiber bundle and a prepreg made thereof were prepared in the same way as Example 1, except changing the highest temperature of the carbonization step to 1,000° C. and the temperature rising rate in carbonization step to 200° C./min. Using the prepreg, a platy carbon fiber reinforced composite material and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this example are shown in Tables 1 to 3. The strand tensile modulus of the produced carbon fiber bundle was low, water content was high, and when a composite thereof was molded, many voids were generated in the composite material and physical properties of the obtained composite material decreased greatly.

### COMPARATIVE EXAMPLE 3

A carbon fiber bundle and a prepreg made thereof were prepared in the same way as Example 1, except changing filament fineness of precursor fiber bundle to 0.8 dtex. Using the prepreg, a platy carbon fiber reinforced composite material and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this comparative example are shown in Tables 1 to 3. The strand tensile modulus of the produced carbon fiber bundle was high, and the flexural modulus of the CFRP shaft also became high.

### COMPARATIVE EXAMPLE 4

A carbon fiber bundle was tried to be made in the same way as Example 1, except changing filament fineness of precursor fiber bundle would be 1.8 dtex. However, many fiber breakages occur in pre-carbonization step and it was impossible to obtain a continuous carbon fiber bundle capable of making a prepreg.

### COMPARATIVE EXAMPLE 5

A copolymer comprising 99.5 mol % acrylonitrile and 0.5 mol % acrylic acid was obtained by a solution polymerization in dimethylsulfoxide as solvent, and obtained a spinning liquid of which copolymer component content is 15 wt %. A spinneret having a spinning hole diameter 0.15 mm and number of spinning holes 3,000 was used. By a dry-jet spinning method in which the spinning liquid was extruded from the spinning holes into air at a temperature of 55° C. and after passing through 4 mm length in air, it was introduced into a coagulation bath comprising an aqueous solution of 55 wt % dimethylsulfoxide which was controlled at a temperature of 20° C., obtained a coagulated fiber bundle. The coagulated fiber bundle washed with water, drawn 3.5 times in hot water at a temperature of 90° C., and then, imparted with an oil agent containing an amino-modified silicone, to thereby obtain a drawn fiber bundle having oil agent. The drawn fiber bundle was subjected to a drying-densification treatment using a hot roller having a temperature of 160° C. Next, the obtained fiber bundle was drawn in a pressurized steam of 0.3 MPa-G. The total draw ratio in the whole fiber production steps was made to 13 times. From these steps, a polyacrylonitrile fiber bundle having a filament fineness of 1.3 dtex and a number of filaments of 3,000 was produced. The lightness difference ΔL of the polyacrylonitrile fiber bundle was 80.

A carbon fiber bundle and a prepreg comprising the carbon fiber bundle were prepared in the same way as Example 1, using the obtained polyacrylonitrile fiber bundle. Using the prepreg, a platy carbon fiber reinforced composite material and a cylindrical CFRP shaft were prepared in the above-mentioned method, and respective mechanical properties were measured. Production conditions of carbon fiber bundle, physical properties of carbon fiber bundle, mechanical properties of platy composite and mechanical properties of cylindrical composite of this comparative example are shown in Tables 1 to 3. Mechanical properties, in particular, strand tensile strength of carbon fiber bundle and tensile strength and torsional strength of composite material decreased greatly.

TABLE 1

| | Production conditions of carbon fiber bundle | | | |
|---|---|---|---|---|
| | | Lightness | | |
| | | difference | | Temperature |
| | Filament | in | | rising rate from |
| | fineness in | precursor | Highest | 1,000° C. to |
| | precursor | fiber | carbonization | highest |
| | fiber bundle | bundle | temperature | temperature |
| | dtex | ΔL | ° C. | ° C./min |
| Example 1 | 1.3 | 35 | 1200 | 500 |
| Example 2 | 1.3 | 35 | 1150 | 500 |
| Example 3 | 1.3 | 35 | 1100 | 200 |
| Example 4 | 1.3 | 20 | 1200 | 500 |
| Example 5 | 1.2 | 35 | 1300 | 300 |
| Example 6 | 1.6 | 35 | 1100 | 500 |
| Example 7 | 1.3 | 35 | 1100 | 3000 |
| Comparative | 1.3 | 35 | 1400 | 200 |
| example 1 | | | | |
| Comparative | 1.3 | 35 | 1000 | 200 |
| example 2 | | | | |
| Comparative | 0.8 | 35 | 1200 | 200 |
| example 3 | | | | |
| Comparative | 1.3 | 80 | 1200 | 500 |
| example 5 | | | | |

TABLE 2

| | Physical properties of carbon fiber bundle | | | | | |
|---|---|---|---|---|---|---|
| | | | Strand | | | |
| | Strand | Strand | tensile | | Carbon | |
| | tensile | tensile | elonga- | Water | crystal | |
| | strength | modulus | tion | content | size Lc | Specific |
| | GPa | GPa | % | % | Å | gravity |
| Example 1 | 4.5 | 200 | 2.3 | 0.4 | 15 | 1.79 |
| Example 2 | 4.0 | 190 | 2.1 | 0.4 | 14 | 1.76 |
| Example 3 | 3.9 | 200 | 2.0 | 0.5 | 13 | 1.75 |
| Example 4 | 5.0 | 190 | 2.6 | 0.4 | 15 | 1.77 |
| Example 5 | 4.6 | 215 | 2.1 | 0.2 | 18 | 1.76 |
| Example 6 | 3.8 | 185 | 2.1 | 0.5 | 13 | 1.74 |
| Example 7 | 3.8 | 190 | 2.0 | 0.5 | 13 | 1.68 |
| Comparative | 3.4 | 230 | 1.5 | 0.1 | 19 | 1.81 |
| example 1 | | | | | | |
| Comparative | 3.2 | 160 | 2.0 | 7.0 | 12 | 1.71 |
| example 2 | | | | | | |
| Comparative | 4.0 | 240 | 1.7 | 0.5 | 15 | 1.80 |
| example 3 | | | | | | |
| Comparative | 2.8 | 210 | 1.3 | 0.3 | 17 | 1.78 |
| example 5 | | | | | | |

TABLE 3

| | Mechanical properties of | | | | | |
|---|---|---|---|---|---|---|
| | platy composite | | | Mechanical properties of | | |
| | 0° | 0° | 0° | cylindrical composite | | |
| | tensile | tensile | compressive | Torsional | Flexural | Flexural |
| | strength | modulus | strength | strength | strength | modulus |
| | MPa | MPa | MPa | N · m · deg | MPa | MPa |
| Example 1 | 3000 | 100 | 1700 | 5000 | 960 | 55 |
| Example 2 | 2700 | 95 | 1800 | 4500 | 1010 | 52 |
| Example 3 | 2500 | 100 | 1850 | 4000 | 1050 | 56 |
| Example 4 | 3200 | 100 | 1700 | 4700 | 970 | 51 |
| Example 5 | 3100 | 130 | 1520 | 4500 | 850 | 60 |
| Example 6 | 2400 | 93 | 1200 | 3700 | 650 | 48 |
| Example 7 | 2300 | 98 | 1100 | 3600 | 640 | 50 |
| Comparative | 2500 | 140 | 1500 | 5000 | 830 | 65 |
| example 1 | | | | | | |
| Comparative | 2200 | 80 | 1000 | 3500 | 580 | 45 |
| example 2 | | | | | | |
| Comparative | 2800 | 150 | 1400 | 4500 | 810 | 68 |
| example 3 | | | | | | |
| Comparative | 1800 | 125 | 1550 | 2600 | 620 | 59 |
| example 5 | | | | | | |

### INDUSTRIAL APPLICABILITY

By the carbon fiber bundle of the invention, a carbon fiber reinforced composite material having a higher compressive strength than that of a carbon fiber reinforced composite material made of conventional carbon fiber bundle is provided. By the carbon fiber bundle of the invention, a carbon fiber reinforced composite material having a lower tensile modulus than that of a carbon fiber reinforced composite material made of conventional carbon fiber bundle is provided. A golf shaft produced by using a prepreg comprising a carbon fiber bundle of the invention and a matrix resin has a high flexural strength and an excellent torsional strength and further, a low flexural modulus. The golf shaft, because of its high flex, while keeping almost the same weight, has a more improved hit feeling and a hitting accuracy, compared to a golf shaft made of conventional carbon fiber reinforced composite material.

The production method of the carbon fiber bundle of the invention is constituted by, using a precursor fiber bundle comprising many polyacrylonitrile-based filaments having a high denseness and a filament fineness in a specific range, and in a carbonization step after stabilizing the precursor fiber bundle, treating the stabilized fiber bundle by making the highest carbonization temperature which affects tensile strength or compressive strength of carbon fiber bundle to be produced in a specific range, and making a temperature rising rate from a temperature of 1,000° C. to the highest carbonization temperature high. By the production method, it becomes possible to make the structural difference in radial direction of the carbon filament which constitutes the carbon fiber bundle to be produced large. As a result, by the production method of the carbon fiber bundle of the invention, a carbon fiber bundle having a low strand tensile modulus can be provided.

1. A carbon fiber bundle which comprises many carbon filaments and has a strand tensile strength of 3.8 to 5.5 GPa, a strand tensile modulus of 180 to 220 GPa and a carbon crystal size Lc of 13 to 18 angstroms.

2. A carbon fiber bundle according to claim 1, wherein a strand tensile elongation of the carbon fiber bundle is 2 to 3%.

3. A carbon fiber bundle according to claim 1, wherein a water content of the carbon fiber bundle is 0.5% or less.

4. A carbon fiber bundle according to claim 1, wherein a specific gravity of the carbon fiber bundle is 1.7 to 1.9.

5. A carbon fiber bundle according to claim 1, wherein the carbon fiber bundle comprises 1,000 to 300,000 carbon filaments.

6. A process for producing a carbon fiber bundle which comprises a stabilization step of a precursor fiber bundle comprising a bundle of many polyacrylonitrile-based filaments each of which has a lightness difference ΔL of 50 or less and a fineness of 1.1 to 1.7 dtex, and a carbonization step for carbonizing a stabilized fiber bundle which is produced by the stabilization step, in an inert atmosphere, at a highest temperature of 1,100 to 1,300° C. and at a temperature rising rate of 100 to 2,000° C./min from a temperature of 1,000° C. to the highest temperature.

7. A process for producing a carbon fiber bundle according to claim 6, wherein the lightness difference ΔL is 40 or less.

8. A process for producing a carbon fiber bundle according to claim 7, wherein the highest temperature is in the range of 1,150 to 1,250° C.

9. A prepreg comprising a carbon fiber bundle of claim 1 and a matrix resin.

10. A prepreg according to claim 9, wherein a weight of the carbon fiber bundle is 10 to 250 g/m².

11. A golf shaft comprising a carbon fiber reinforced composite material made of a carbon fiber bundle according to claim 1 and a resin.

12. A golf shaft comprising a carbon fiber reinforced composite material which is produced by curing the matrix resin of the prepreg according to claim 9.

13. A prepreg comprising a carbon fiber bundle of claim 2 and a matrix resin.

14. A prepreg comprising a carbon fiber bundle of claim 3 and a matrix resin.

15. A prepreg comprising a carbon fiber bundle of claim 4 and a matrix resin.

16. A prepreg comprising a carbon fiber bundle of claim 5 and a matrix resin.

17. A golf shaft comprising a carbon fiber reinforced composite material made of a carbon fiber bundle according to claim 2 and a resin.

18. A golf shaft comprising a carbon fiber reinforced composite material made of a carbon fiber bundle according to claim 3 and a resin.

19. A golf shaft comprising a carbon fiber reinforced composite material made of a carbon fiber bundle according to claim 4 and a resin.

20. A golf shaft comprising a carbon fiber reinforced composite material made of a carbon fiber bundle according to claim 5 and a resin.
